(19) United States
(12) Patent Application Publication
(10) Pub. No.: US 2003/0138624 A1
(43) Pub. Date: Jul. 24, 2003

(54) SELF-ADHESIVE TAPE COMPRISING MICROBALLOONS IN THE BACKING LAYER

(76) Inventors: AXEL BURMEISTER, BUCHHOLZ (DE); CHRISTIAN HARDER, HAMBURG (DE); CHRISTOPH NAGEL, HAMBURG (DE); WOLFGANG SCHACHT, NEU-WULMSTORF (DE); JOCHEN STAHR, HANNOVER (DE)

Correspondence Address: NORRIS MCLAUGHLIN & MARCUS, 220 East 42nd Street- 30th Floor, NEW York New YORK, NY, 10017, US

(21) Appl. No.: 09/462,987

(22) PCT Filed: Jul. 10, 1998
(86) PCT No.: PCT/EP98/04278

(30) Foreign Application Priority Data
Jul. 18, 1997 (DE) 197 30 854.6

(51) Int. Cl. B32B 7/12; B32B 15/04

(52) U.S. Cl. 428/343; 428/354

(57) ABSTRACT

Pressure-sensitive self-adhesive tape, characterized in that the self-adhesive tape has a backing layer which

a) is coated on both sides with a pressure-sensitive adhesive composition and

b) comprises microballoons in a proportion by volume of from 1 to 95% by volume, in particular from 30 to 70% by volume.

The invention relates to a double-sided self-adhesive tape as is employed in particular for obtaining highly durable bonds of articles having unevennesses in the surfaces to be bonded.

In order to achieve greater resistance to peeling and shear forces it is known to use different adhesive tapes.

DE-C 21 05 877 reveals an adhesive tape consisting of a backing which is coated on at least one side with a microcellular pressure-sensitive adhesive and whose adhesive layer comprises a nucleating agent, the cells of the adhesive layer being closed and being distributed completely within the adhesive layer. This adhesive tape has the ability to adapt to the irregular surface to which it is applied and hence to lead to a relatively durable bond, yet on the other hand exhibits only minimal recovery when compressed to half its original thickness. The voids in the adhesive composition, however, offer starting points for the lateral ingress of solvents and water into the joint, which is highly undesirable. Furthermore, it is impossible to rule out the complete penetration of solvents or water through the entire adhesive tape.

Thus DE-C 28 21 606 describes a pressure-sensitive adhesive tape comprising an adhesive layer which is disposed on a backing material and in which hollow glass microbeads are dispersed with a proportion of up to 60 percent by volume of the adhesive layer. The structure of this adhesive tape provides it with good resistance to the abovementioned stresses. This is because the tape possesses the technical advantage of showing virtually no lifting from unevennesses in the substrate, since it lacks elastic recovery after a pressure has been exerted on it for some time. However, this adhesive tape is also hampered by certain disadvantages. For instance, hollow glass microbeads are highly sensitive structures which, in the course of incorporation into the adhesive layer, on storage and, in particular, when the tape is being used, show a tendency to burst, with subsequent consequential problems owing to the splinters which are formed.

DE-A 40 29 896 describes an unbacked double-sided self-adhesive tape consisting of a pressure-sensitive adhesive layer which comprises solid glass microbeads.

DE 196 03 919 describes a self-adhesive tape which is coated on both sides with a pressure-sensitive adhesive and has a rubber backing layer in which solid microbeads, especially glass microbeads, have been mixed.

EP-A 0 257 984 discloses adhesive tapes which on at least one side have an adhesive coating on a backing layer. This adhesive coating contains polymer beads which in turn contain a hydrocarbon-comprising liquid. At elevated temperatures, the polymer beads tend to expand.

A defect common to all of the abovementioned adhesive tapes is that the level of shear forces acting on the bonded joint which can be accommodated is for many applications insufficient to ensure a durable bond between the substrate and the article which is to be mounted by means of the adhesive tape. For instance, especially at relatively low temperatures, the possibilities of using such adhesive tapes are extremely limited, since at low temperatures the backing becomes brittle and so the adhesive tape is no longer able to maintain the desired bond. At relatively high temperatures as well the bond strengths of the adhesive tapes are reduced as a result, inter alia, of flow processes. Consequently, the possibility of using the adhesive tapes at high temperatures is absent or extremely limited.

The object on which the invention is based is to provide a self-adhesive tape which does not have the disadvantages of the prior art, or at least not to the same extent, and which nevertheless is not restricted, like the products known to date, in its fitness for use.

In order to achieve this object the invention proposes a pressure-sensitive self-adhesive tape, coated on both sides with pressure-sensitive adhesive compositions, whose backing layer comprises microballoons in a proportion by volume of from 1 to 95% by volume, in particular from 30 to 70% by volume.

As the material for the backing layer it is preferred to employ natural rubbers, acrylonitrile-butadiene rubbers, butyl rubbers or styrene-butadiene rubbers, a blend of these rubbers or polyolefins such as polyethylene or polypropylene, ethylene-vinyl acetate, acrylate or a compound of the said polymers.

In order to establish specifically the desired properties of the backing, it is possible if desired to use fillers. Thus the backing layer can be admixed with a carbon black from the range of the reinforcing, semi-reinforcing or non-reinforcing blacks, in particular between 0-80 phr, zinc oxide, in particular between 0-70 phr, and/or other fillers, such as silica, silicates or chalk. In addition to those mentioned it is also possible to use further fillers. Resins from the class of the phenolic resins and/or hydrocarbon resins can also be added, in the range, in particular, between 0-75 phr.

In order to enhance the stability of the adhesive tape it can be filled with customary ageing inhibitors, which depending on the particular application may come from the class of the colouring or non-colouring ageing inhibitors, in particular in the range between 0-10 phr, and with known light stabilizers or ozone protectants. Also possible is blending with vulcanizing agents (such as peroxides or sulphur, sulphur donors or accelerators, for example) and/or the addition of fatty acids, in particular in the range of 0-10 phr, and also the use of plasticizers. Depending on the intended use of the self-adhesive tape, all of these additives mentioned can be employed either alone or in any desired combination of one another for preparing the rubber mixture in order to obtain optimum adaptation to the use. By employing these additives it is also possible without problems to give the backing the black coloration which is generally required by the industry.

With regard to the rubbers, particular reference is made here to the known technology of rubber processing and to the known additives employed for this purpose, in accordance, for instance, with the book by Werner Kleemann (Werner Kleemann: _{“Mischungen fur die Elastverarbeitung”, Deutscher Verlag für Grundstoffindustrie, Leipzig} 1982).

The backing mixture is preferably prepared in an internal mixer of the kind typical for elastomer compounding. In this case the mixture is adjusted in particular to a Mooney value ML₁₊₃ (100° C.) in the range from 10 to 80. Processing takes place preferably without solvent. In a second operation, without heating, optional crosslinkers, accelerators and the desired microballoons are added to the mixture. This second operation takes place at temperatures below 70° C. in a customary commercial kneading apparatus, internal mixer, mixing rolls or twin-screw extruder. The mixture can subsequently be calendered and/or extruded to the desired thickness on customary commercial machines.

The resulting thickness of the backing lies within the range from 30 to 2000 μm, in particular from 200 to 1250 μm.

The backing is subsequently provided on both sides with a customary commercial pressure-sensitive self-adhesive composition, thermally foamed and optionally crosslinked.

During these steps, the expansion of the microballoons results preferably in a backing thickness in the range from 200 to 4000 μm, in particular from 400 to 2500 μm.

Subsequently, as an option, it is possible to carry out electron beam curing. In addition to electron beam curing, crosslinking by means of UV radiation can also be effected. Depending on the desired degree of crosslinking it is advisable to add promoters and/or initiators to the backing layer.

In order to increase the anchoring of the adhesive composition on the rubber backing it is possible to add known adhesion promoters. It is also possible to apply a known primer coating to the backing. Alternatively to this, the backing can also be corona-pretreated. In order to obtain particularly firm anchorages, moreover, a combination of the methods set out is possible.

To prevent migration of the substances employed in the backing layer into the layer of adhesive, a barrier layer having a thickness of from 2 to 10 μm, preferably from 2 to 4 μm, is applied in a preferred configuration between backing layer and self-adhesive composition.

The adhesive composition can itself be applied directly from solution, dispersion or melt or in an indirect transfer method or by coextrusion with the backing. In the case of coextrusion in particular it is advantageous to carry out in-line crosslinking of backing and adhesive composition by means of electron beam curing. The amount of adhesive composition applied can likewise be chosen within the range of 10-250 g/m², preferably 40-150 g/m², arbitrarily depending on the intended use.

The backing layer comprises microballoons. The microballoons are elastic, thermoplastic hollow beads which have a polymer shell. These beads are filled with low-boiling liquids or with liquefied gas. Suitable shell polymers are, in particular, acrylonitrile, PVDC, PVC or acrylates. Hydrocarbons such as the lower alkanes—pentane, for example—are suitable as a low-boiling liquid, while a suitable liquefied gas is a chemical such as isobutane.

The self-adhesive tape of the invention exhibits particularly advantageous properties when the microballoons have a diameter at 25° C. of from 3 to 40 μm, in particular from 5 to 20 μm.

Exposure to heat makes the capsules stretch irreversibly and expand three-dimensionally. Expansion comes to an end when the internal pressure is equal to the external pressure. In this way a closed-celled foam backing is obtained which features good flow behaviour and high recovery forces.

Following thermal expansion due to elevated temperature, the microballoons advantageously have a diameter of from 20 to 200 μm, in particular from 40 to 100 μm.

This expansion can take place prior to or following incorporation into the polymer matrix, but also prior to or following incorporation into the polymer matrix and shaping.

It is also possible to carry out the expansion following incorporation into the polymer matrix and prior to shaping.

Through the use of microballoons in the backing layer, the self-adhesive tape exhibits outstanding properties which were unforeseeable as such to the skilled worker. Owing to the high flexibility of the backing, the adhesive tape conforms very well to an uneven substrate when pressed onto it with a certain pressure. This produces a highly durable bond between adhesive tape and substrate, which does not fail even when high shear forces act on the self-adhesive tape. Owing to the absence of laterally open voids in the backing, moreover, the possibility of penetration of solvents or water into the adhesive tape, with all of its known disadvantages, is prevented.

Further advantages of the adhesive tapes blended with microballoons over those produced using solid microbeads are that the microballoons have a much lower density, thus lightening the adhesive tape as a whole. In addition, adhesive tapes of the invention also exhibit heightened recovery forces relative to the hollow glass bead variant. They also have the advantage that, following exposure to pressure, there are no disruptive wall pieces to disrupt the performance.

Finally, mention may also be made of the lower price of a backing filled with microballoons relative to those filled with solid or hollow beads.

The adhesive tape of the invention offers an ideal combination of viscoelastic properties with a high recovery moment.

In summary, the use of the self-adhesive tape of the invention is recommended when the intention is to achieve durable bonds having high shear strength, tip-shear strength, high bond strength and high low-temperature impact strength.

The invention is utilized, for example, in the furniture industry, where there is a need for permanent anchorage for mirrors, strips or panels to the substrate.

Owing to the outstanding properties of the product, however, the use of the invention is not restricted to the example given. Rather, the adhesive tape can be used as an assembly material in numerous sectors of industry whenever there is a need to bring about a secure bond between two parts of the most widely differing materials on a relatively uneven surface.

The intention of the text below is to describe the invention in more detail by way of several examples without wishing thereby to restrict the invention unnecessarily.

### EXAMPLE 1

The initial batch of the backing mixture is prepared in an internal mixer of the type typical for compounding elastomers, and the preparation takes place within five minutes at a temperature of 130° C.

Formulation:

| Component | Proportion (phr) |
|---|---|
| Natural rubber CV 50 | 100.0 |
| Ground chalk | 51.0 |
| Wing Tack 10 soft resin (from Goodyear) | 20.0 |
| Zinc oxide | 5.0 |
| TiO₂ | 5.0 |
| Stearic acid (from Pronova) | 1.0 |
| Total initial batch | 182.0 |

The mixture is then finished in a customary commercial kneading apparatus for eight minutes at a temperature of 45° C., during which the following additional substances are added to the initial batch:

| Component | Proportion [%] |
|---|---|
| Initial batch | 94.4 |
| Ageing inhibitor | 0.9 |
| Rhenogran S-80 (from Rheinchemie) | 0.3 |
| Rhenogran ZEPC-80 (from Rheinchemie) | 0.3 |
| Rhenogran HX (from Rheinchemie) | 0.1 |
| FQ 2134 microballoons (from Follmann) | 3.8 |
| Total | 100 |

The mixture is subsequently drawn out on a customary 4-roll F-type calender to give a web with a thickness of 0.500 mm (corresponding to approximately 590 g/m²) at a roll temperature of 70° C. in each case and at a web speed of 5 m/min. The web is then covered with a release covering and wound up into a roll.

The crosslinked backing is provided on both sides with an epoxy-based dispersion primer.

The material is then coated in two steps on both sides with 60 g/M² per side of the polyacrylate composition Duroctac 280-1753 from National Starch by the transfer method.

The backing layer is also foamed and crosslinked, at a temperature of 130° C. and a rate of 2 m/min. The resulting thickness of the backing was 1000 μm.

The double-sided adhesive tape covered on one side with release paper is notable for high bond strengths coupled with high shear strength, and the bonds produced therewith possess excellent strengths at high and low temperatures.

### EXAMPLES 2 TO 6

Formulations below describe the possibility of preparing crosslinked and foamed backing systems on a broad raw-material basis.

The crosslinked, foamed backings are finally coated on both sides—in two steps, if desired—with 60 g/m² per side of the polyacrylate composition Duroctac 280-1753 from the company National Starch by the transfer method to produce a double-sided adhesive tape.

The preparation of the polymer systems required for the backings, where the said systems are not available commercially, is described below:

General Preparation of the Polymers

The following monomer mixtures (amounts in % by weight) were copolymerized in solution. The polymerization batches consisted of from 60 to 80% by weight of the monomer mixtures and of from 20 to 40% by weight of solvents such as petroleum spirit 60/95 and acetone.

The solutions were first of all freed from oxygen by flushing with nitrogen, and then heated to boiling, in customary reaction vessels made of glass or steel (with reflux condenser, anchor stirrer, temperature measurement unit and gas inlet tube).

The polymerization was triggered by the addition of from 0.1 to 0.4% by weight of an azo or peroxide initiator customary for free-radical addition polymerization, such as, for example, dibenzoyl peroxide or azobisisobutyronitrile. During the polymerization period of approximately 20 hours, further diluent was added, possibly a number of times depending on the viscosity increase, so that the final polymer solutions had a solids content of between 25 and 65% by weight.

Depending on requirements and suitability, the compositions prepared in this way were blended further and coated from the solution or, respectively, following removal of the solvent, as is described in EP 0 621 326.

Depending on the formulation and the nature of the additives, the blends were made either before or after concentration in apparatus suitable accordingly for the purpose.

In the text below, with reference to examples, backing formulations are described in combination with appropriately suitable crosslinking modes, along with the effects brought about by foaming.

### EXAMPLE 2

### Acrylate, Chelate Crosslinking

The following monomer composition was prepared:

| | % by weight |
|---|---|
| 2-Ethylhexyl acrylate | 21 |
| n-Butyl acrylate | 21 |
| tert-Butyl acrylate | 50 |
| Acrylic acid | 8 |

Based on the polymer fraction, the composition was blended with 0.8% by weight of titanium chelate and 3% by weight of microballoons (FQ 2134, from Follmann) and the blend was coated onto release paper at about 60 g/m² and dried at from 60 to 70° C. The dried films of composition were laminated to give an overall composite thickness of 120 g/m².

The material was subsequently foamed at 130° C. for 3 minutes.

The foaming rate was 200%.

### EXAMPLE 3

### Acrylate; Chemical Crosslinking by Means of Isocyanate

As indicated in Example 2, a polymer was prepared from the following monomers.

| | % by weight |
|---|---|
| n-Butyl acrylate | 80 |
| N-tert-Butylacrylamide | 14 |
| 2-Hydroxypropyl acrylate | 6 |

The composition was blended with 3.0% by weight of Desmodur TT, 0.05% by weight of DBTL and 4% by weight of microballoons.

In variant 1, the composition was applied from solution to release paper and dried at from 60 to 70° C.

A backing approximately 120 μm thick was produced by lamination.

In variant 2, the solvent was removed from the polymer prior to blending. The 100% system produced in this way was, as described in variant 1, blended and coated with a mass add-on of 120 μm on a customary roller applicator system at 80° C.

In both cases, the films of composition were subsequently foamed at 130° C. for 5 minutes. The foaming rate was approximately 230%.

### EXAMPLE 4

### Acrylate, Crosslinking by Means of Electron Beams

The polymer formulation described in Example 3 was blended

in variant 1 with 3% by weight of microballoons and was coated from solution. The composition dried at 70° C. was laminated to give a film thickness of 120 μm.

In variant 2, the solvent was removed from the said formulation, which was then blended with 3% by weight of microballoons and, as described in Example 3, variant 2, was coated from the melt at 80° C. on a customary roller applicator system.

The viscoelastic behaviour of the backings could be varied if required by adding EB crosslinking promoters, such as, for example, SR 295 from SARTOMER.

The films were EBC-crosslinked on both sides with 100 kGy and subsequently foamed at 130° C. for 3 minutes. The foaming rate was from 150 to 160%.

### EXAMPLE 5

### Acrylate, Crosslinking by Means of UV Rays

The formulation below is given as an example of a series of formulations which permit crosslinking of the backing by means of UV.

A polymer was prepared from the following monomers.

| | % by weight |
|---|---|
| n-Butyl acrylate | 78 |
| N-tert-Butylacrylamide | 20 |
| Benzoin acrylate | 2 |

The composition was blended

in variant 1 with 3% by weight of microballoons and was coated from the solution onto release paper and dried at 70° C. The composite had a thickness of about 120 μm and was crosslinked on both sides with a UV drier from the company Eltosch-Torsten-Schmidt GmbH at 1 m/min, 600 V and 10 A.

In variant 2, as described, the composition was freed from solvent, blended with 3% by weight of microballoons and coated onto release paper with a mass add-on of 120 μm at 80° C. on commercially customary roller applicator units.

The viscoelastic behaviour of the backings and the crosslinkability of relatively thick films could be varied if required by adding UV crosslinking promoters, such as, for example, Speedcure ITX from Lambson.

The foaming rate was 205%.

### EXAMPLE 6

### Blends of Acrylate/EVA, Crosslinking by Means of Electron Beams

On a roller bed, a blend was prepared from 3 parts of EVA (LEVAPREN 450, Bayer) and 1 part of acrylate (ACRONAL 3458; BASF). The composition was blended with 3% by weight of microballoons. The homogeneous mixture obtained in this way was, as described, coated onto release paper with a mass add-on of about 120 μm as a 100% system.

The film produced in this way was subsequently crosslinked on both sides with 50 kGy. After heat treatment at 130° C. for 3 minutes, the foaming rate was 190%.

### EXAMPLE 7

### EVA, Crosslinking by Means of Electron Beams

Pure EVA compositions are likewise suitable as a backing system, as described below.

In this context, blends of different EVA types are also possible.

A composition based on LEVAPREN 450 was blended with 3% by weight of microballoons and, as described in Example 5, was coated, crosslinked and foamed.

The foaming rate was 150%.

1. Pressure-sensitive self-adhesive tape, characterized in that the self-adhesive tape has a backing layer which
a) is coated on both sides with a pressure-sensitive adhesive composition,
b) comprises microballoons in a proportion by volume of from 1 to 95% by volume, in particular from 30 to 70% by volume, and
c) is crosslinked fully or partly and chemically or physically by means of ionizing radiation.

2. Self-adhesive tape according to claim 1, characterized in that the backing layer consists of natural rubber, acrylonitrile-butadiene rubber, butyl rubber, styrene-butadiene rubber, a blend of these rubbers, or of a polyolefin, ethylene-vinyl acetate, acrylate or a compound of these polymers.

3. Self-adhesive tape according to claim 1, characterized in that the backing layer is blended with one or more additives such as ageing inhibitors, crosslinkers, light stabilizers, ozone protectants, fatty acids, resins, plasticizers and vulcanizing agents, electron beam curing promoters or UV initiators.

4. Self-adhesive tape according to claim 1, characterized in that the backing layer is filled with one or more fillers such as carbon black, zinc oxide, silica, silicates and chalk.

5. Self-adhesive tape according to claim 1, characterized in that the backing comprising expanded microballoons has a thickness of from 200 to 4000 μm, in particular from 400 to 2500 am.

6. Self-adhesive tape according to claim 1, characterized in that the backing has adhesion promoters in order to improve the adhesion of the adhesive compositions.

7. Self-adhesive tape according to claim 1, characterized in that between the backing layer and the self-adhesive composition there is a barrier layer having a thickness of from 2 to 10 μm, preferably from 2 to 4 μm.

8. Self-adhesive tape according to claim 1, characterized in that the microballoons have a polymer shell which is filled with low-boiling liquids or with liquefied gas.

9. Self-adhesive tape according to claim 9, characterized in that at 25° C. the microballoons have a diameter of from 3 to 40 μm, in particular from 5 to 20 μm.

10. Self-adhesive tape according to claim 9, characterized in that, following exposure to temperature, particularly a temperature above 70° C., the microballoons have a diameter of from 20 to 200 μm, in particular from 40 to 100 μm.

11. Self-adhesive tape according to claim 9, characterized in that the microballoons are expanded following incorporation into the polymer matrix and shaping.

12. Self-adhesive tape according to claim 9, characterized in that the microballoons are expanded prior to incorporation into the polymer matrix and shaping.

13. Self-adhesive tape according to claim 9, characterized in that the microballoons are expanded following incorporation into the polymer matrix and prior to shaping.

14. Use of a self-adhesive tape according to claims 1 to 14 for obtaining durable bonds with high shear strength, tip-shear strength, high bond strength and high low-temperature impact strength.
